(19) United States
(12) Patent Application Publication
(10) Pub. No.: US 2019/0100222 A1
(43) Pub. Date: Apr. 4, 2019

(54) RAILWAY VEHICLE COMPRISING A LIGHT STRIP

(71) Applicant: ALSTOM Transport Technologies, Saint-Ouen (FR)

(72) Inventor: Bertrand Faure, LA MADELEINE (FR)

(21) Appl. No.: 16/148,741

(22) Filed: Oct. 1, 2018

(30) Foreign Application Priority Data
Sep. 29, 2017 (FR) 1759112

(51) Int. Cl. B61D 29/00; F21S 9/03; F21V 23/02; F21S 45/10; F21S 43/15; F21S 43/145; F21S 43/14

(52) U.S. Cl. CPC B61D 29/00; F21S 9/032; F21V 23/02; F21Y 2115/10; F21S 43/15; F21S 43/145; F21S 43/14; F21S 45/10

(57) ABSTRACT

The rail vehicle (1) comprises front end (100) and rear end (102) and side faces (104) and a light strip (3) fixed to the outside of the railway vehicle (1) and comprising a light source. The light strip (104) is fixed on at least either the front end (100) or rear end (102) and on the side faces, and extends over at least 50% the length of each of the side faces (104).

The invention relates to a railway vehicle comprising a light strip placed on the external bodywork of this vehicle.

Railway vehicles are known that are provided with one or more headlights placed at the front of the vehicle. These headlights are typically designed to illuminate the railway track in front of a train to allow a train driver to see the track when it is dark. However, when the train is brought into an area where pedestrians are near the tracks, as is the case with streetcars, these headlights do not allow the train to be visible from afar. This results in a risk of increased collision between pedestrians and the train.

It is these drawbacks that the invention intends to remedy more particularly by proposing a railway vehicle which has increased external visibility when it is traveling under conditions of poor visibility.

To this end, the invention relates to a railway vehicle comprising front and rear ends and side faces carrying a light strip that is fixed to the outside of the railway vehicle and comprising a light source. According to the invention, the light strip is fixed on at least one of the front and rear ends and the side faces and extends over at least 50% of the length of each of the side faces.

By virtue of the invention, the light strips at least partly match the shape of the train and, when illuminated, they thus allow the size and shape of the train to be perceived in the dark.

According to advantageous but non-obligatory aspects of the invention, such a railway vehicle may incorporate one or more of the following features, taken in any technically feasible combination:
the vehicle has bodywork at least partly forming the side faces, wherein the light strip is fixed on this bodywork.
the light strip extends along an edge separating sections of the bodywork.
the light strip extends over the entire length of the side faces.
the light strip is a flexible film.
the light source comprises a light-emitting diode or an organic light-emitting diode.
the vehicle comprises a power supply unit that is capable of electrically powering the light source.
the power supply unit has a photovoltaic module attached to the outside of the railway vehicle.
the power supply unit is powered by a power supply network of the railway vehicle.
the light strip has a transparent outer protective layer that covers the light source.

The invention will be better understood and other advantages will emerge more clearly in the light of the description which follows of an embodiment of a railway vehicle, in accordance with its concept and given solely as a example and with reference to the accompanying drawings, wherein:

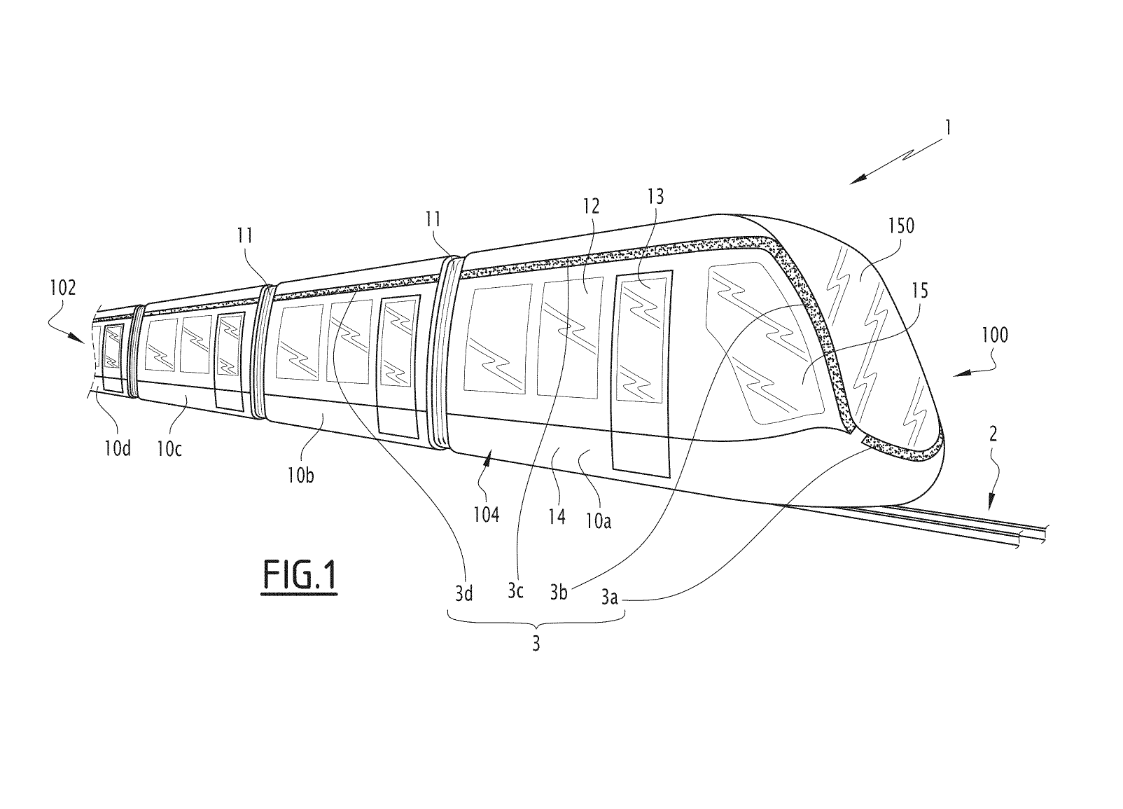

FIG. 1 shows schematically, in a perspective view, a railway vehicle provided with a light strip according to the invention;

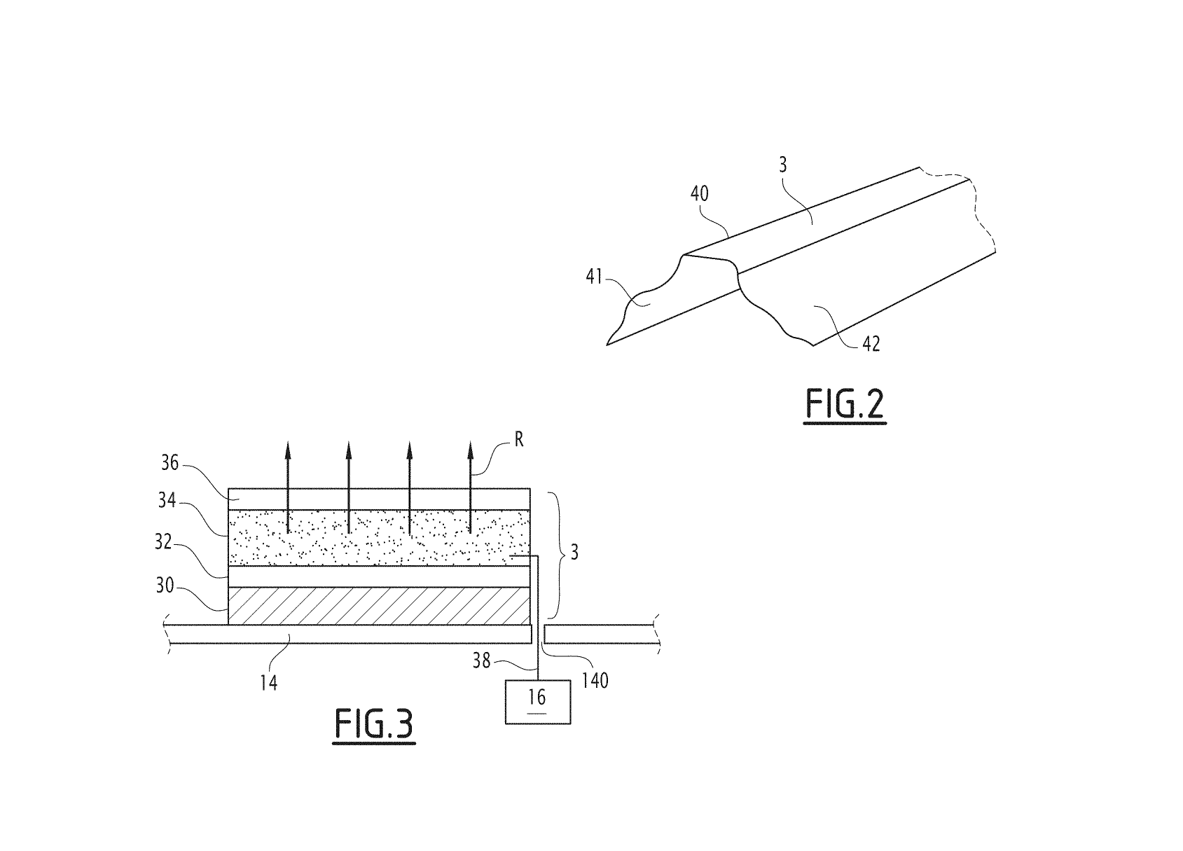

FIG. 2 shows a schematic sectional view of an example of the placing of the light strip of FIG. 1,

FIG. 3 shows a schematic sectional view of a section of the light strip of FIG. 1.

FIG. 1 shows a railway vehicle 1 that is able to travel on a railway 2. In this example, the vehicle 1 is a tram.

The vehicle 1 comprises a front end 100, a rear end 102 and outer side faces 104, of which only one is visible in FIG. 1.

In this case, the vehicle 1 comprises a plurality of cars 10a, 10b, 10c and 10d mounted on bogies (not shown). These cars 10a, 10b, 10c and 10d are aligned along a longitudinal axis of the vehicle 1 and are coupled in pairs by articulations 11 to form the body of the vehicle 1.

Each car 10a, 10b, 10c and 10d also comprises a front part, a rear part and side faces. The respective front and rear faces of each pair of adjacent cars 10a, 10b, 10c and 10d are arranged to face each other and are coupled in pairs by one of the articulations 11. The front end of the car 10a located in front of the vehicle 1 corresponds to the front end of the vehicle 1. Similarly, the rear end of the body 10d located at the rear of the vehicle 1 corresponds to the rear end of the vehicle 1.

Alternatively, the vehicle 1 may have only one body. In this case, the articulations 11 are omitted.

Each car 10a, 10b, 10c and 10d also has openings and external bodywork 14. The openings are, for example, windows 12 and/or doors 13. They are arranged on the side faces of the car 10a, 10b, 10c and 10d. The outer bodywork 14 is attached to each car 10a, 10b, 10c and 10d and comprises, for example, metal sheets or panels of plastic or composite material. Thus, each side face 104 of the vehicle 1 is formed by the corresponding side faces of each of the cars 10a, 10b, 10c and 10d and, more precisely, by the bodywork of these cars 10a, 10b, 10c and 10d. Advantageously, additional bodywork elements are arranged on one or more of these cars, for example to hide equipment located on the roof of the vehicle 1.

At least either the front end 100 or rear end 102 has an operator's cab to drive 15 the vehicle 1.

The vehicle 1 further comprises a light strip 3 fixed to the outside of the vehicle 1, in this case on the bodywork of the vehicle 1, as described below. Alternatively, the bodywork 14 may be omitted and the strip 3 directly attached to the cars 10a, 10b, 10c and 10d.

The strip 3 is able to emit light radiation when it is electrically powered by a power supply unit 16 of the vehicle 1. The supply unit 16 is a DC voltage source placed inside the vehicle 1 and that is able to supply a voltage, for example 24V or 110V. The unit is itself powered by a power source, for example a vehicle battery 1 or via an external power supply network of the vehicle 1, such as a catenary. According to another variant, the power supply unit 16 comprises a photovoltaic module placed outside the vehicle 1, for example on the roof of the vehicle 1.

The strip 3 extends at least on either the front end 100 or rear end 102 and over at least 50% of the length of the side faces 104, preferably at least 70% or at least 80% of the length of the side faces 104. In this case, the strip 3 extends over the entire length of the side faces 104. The length is measured along the longitudinal direction of the vehicle 1.

In this case, the strip 3 does not extend as one piece but is divided into a plurality of strip sections 3a, 3b, 3c, 3d that are contiguous with each other except at the articulations 11. In this case, these sections of the strips are similar to each other and only differ from each other in their respective dimensions and positions.

In this example, a first section 3a of the strip 3 extends horizontally along the front end 100 of the vehicle 1, for example along and below a windshield 150 of the operator's cab 15. Two second portions 3b of the strip 3, of which only one is visible in FIG. 1, extend substantially vertically on each side of the windshield 150, then along the windshield 150 to the additional fairing of the roof. The lower end of each second section 3b is adjacent to one end of the strip 3a in order to ensure at least visual continuity of the strip 3. Two third sections 3c of the strip 3 each extend substantially horizontally along the length of the corresponding face 104 of this car 10a until they reach the articulation 11. The cars 10b and 10c each have, on each of their respective side faces, a section 3d of the strip 3 which extends as the extension of the corresponding section 3c. In this case, the vehicle 1 is a reversible tram that is provided at its two longitudinal ends with identical operator cabs 15. The ends 100 and 102 therefore have the same shape. Therefore, the end 102 has sections 3a and 3b of the strip 3 that are arranged in a similar manner to the arrangement of the sections 3a and 3b of the end 100 previously described. The car 10d further comprises sections 3c of the strip 3 similar to those of the car 10a.

Each of the sections 3a, 3b, 3c and 3d here has a width greater than 1 cm and less than 50 cm, preferably between 5 and 30 cm. In this description, the horizontal direction is defined as being parallel to the railway 2.

Preferably, the strip 3 is arranged along an edge 40 or an angle line which separates two sections 41, 42 of a face of the bodywork 14 which have different orientations, as illustrated in FIG. 2.

As shown in FIG. 3, the strip 3 is in the form of a flexible film of substantially flat shape. By “film” is meant that the thickness of the strip 3 is at least ten times less, preferably at least one hundred times less, than the smallest dimension between the length and the width of the strip 3, wherein this length and this width are measured in the plane of the strip 3.

In this example, each section of the strip 3 comprises a stack comprising a fixing support 30, an intermediate protective layer 32, an active light source 34 and an outer protective layer 36, superimposed upon each other in this order towards the outside on the bodywork 14. This stack advantageously has a thickness less than or equal to 5 mm, preferably 3 mm, more preferably 1 mm. Preferably, the stack has the lowest possible thickness, in order to avoid excessive width on the bodywork 14, which could adversely affect the aerodynamic performance or impair the ease of maintenance, for example when washing the vehicle 1.

The support 30 is intended to be fixed in contact with the bodywork of the vehicle 1 in order to secure the strip 3 without any degree of freedom with the vehicle 1. For example, the support 30 may be an aluminum film, or a metal sheet. The fixing is effected using a fixing system, such as an adhesive or a screw/nut system.

The intermediate layer 32 is arranged between the support 30 and the light source 34 and serves to protect the support 30 against corrosion and other damage resulting from the exposure of the strip 3 outside the vehicle 1. The intermediate layer 32 is formed of a layer of protective paint. Alternatively, the intermediate layer 32 may be omitted, especially if it is desired to reduce the thickness of the strip 3.

The light source 34 emits a light radiation R when it is powered by the unit 16. For this purpose, the light source 34 is connected to the unit 16, for example by means of an electrical cable 38 which passes through a through-hole 140 formed in the bodywork 14.

The light radiation R emitted has a wavelength comprised in the visible range, i.e. between 350 nm and 800 nm. The radiation R is here monochromatic.

Moreover, the luminous radiation R advantageously provides illuminance greater than or equal to 100 lux, preferably greater than or equal to 500 lux, more preferably greater than or equal to 1000 lux.

The light source 34 emits the light radiation R only when it is powered by the unit 16. Thus, fluorescent or retro-reflective films are not light strips within the meaning of the invention.

The light source 34 here has the form of a flexible sheet that extends continuously over at least 90%, preferably at least 95%, of the area of the strip section. This sheet is attached to the intermediate layer 32, for example, by means of a layer of adhesive or double-sided adhesive or by rolling.

For example, the light source 34 is a light emitting diode module, known by the acronym LED.

As a variant, the light source 34 may be an organic light-emitting diode module, known by the acronym OLED. In this case, the wavelength of the light emitted by the light source 34 may be advantageously and selectively modified by a user, for example by modifying the power supply parameters of the light source 34 by means of a selection interface of the vehicle 1. This allows, for example, the strip 3 to display a different color depending on the route of the vehicle 1 thus allowing easy identification by travelers. This also allows, for example the strip 3 to display a different color depending on whether the vehicle is in commercial service or not.

The protective layer 36 covers the light source 34 to protect it from damage resulting from the exposure of the strip 3 to environmental conditions, such as moisture or ultraviolet radiation. For example, the protective layer 36 may be a protective varnish.

Advantageously, the vehicle comprises control means for the power supply unit 16 that are able to control the power supply of the light source 34 for a predetermined period. The predetermined period may be, for example, of the order of second.

The control means are, for example, activated via the selection interface. An operator driving the vehicle 1 is thus able, via the selection interface, to control the flashing of the light source 34, in particular during a change of direction of the vehicle 1, or in a dangerous situation.

The vehicle 1 defines two side faces on either side of a first plane of the vehicle extending parallel to a longitudinal axis and to a vertical axis of the vehicle 1. These side faces correspond, for example, to the side faces 104. Advantageously, the vehicle 1 comprises a strip 3 arranged along each side face of the vehicle, wherein each strip is associated with a separate power supply unit 16, in order to control the power supply of the strips independently.

The protective layer 36 is advantageously transparent to allow propagation of the radiation emitted by the source 34 to the outside from the strip 3.

By virtue of the light strip 3, the visibility of the vehicle 1 is increased. As the strip 3 extends along the faces 104, it makes it possible to illuminate and cause the shape and the overall dimensions of the vehicle 1 to appear more effectively than a headlight placed at the end 100 which does not allow this, because such a headlight only illuminates the area in front of the vehicle 1, and thus does not illuminate the rest of the vehicle 1.

In addition, by its shape and structure, the strip 3 easily adapts to the shape of the bodywork 14, especially when the bodywork has a customized shape. A single type of strip 3 may therefore be used on different types of vehicles 1 having different external shapes.

The invention also applies in the case where the vehicle 1 is other than a tram and where increased visibility in the dark or at night time is sought. For example, the vehicle 1 may be a work train. The strip 3 thus makes it possible to increase the nighttime visibility of such a train by workers working near this train in a work zone. According to another variant, the vehicle 1 may be a convoy of goods wagons pulled by a locomotive. The strip 3 then makes it possible to increase the visibility of this convoy in a goods' sorting facility.

1. A railway vehicle, comprising:
a front end, a rear end and side faces, and
a light strip fixed to the outside of the railway vehicle and comprising a light source,
wherein the light strip is fixed on at least either the front end or rear end and on the side faces, and extends over at least 50% of the length of each of the side faces.

2. The railway vehicle of claim 1, wherein the railway vehicle comprises bodywork that at least partly forms the side faces and in that the light strip is fixed on this bodywork.

3. The railway vehicle of claim 2, wherein the light strip extends along an edge separating sections of the faces of the bodywork.

4. The railway vehicle of claim 1, wherein the light strip extends over the entire length of the side faces.

5. The railway vehicle of claim 1, wherein the light strip is a flexible film.

6. The railway vehicle of claim 1, wherein the light source comprises a light emitting diode or an organic light emitting diode.

7. The railway vehicle of claim 1, wherein the vehicle comprises a power supply unit designed to electrically power the light source.

8. The railway vehicle of claim 7, wherein the power supply unit comprises a photovoltaic module attached to the outside of the railway vehicle.

9. The railway vehicle of claim 7, wherein the power supply unit is supplied by an electrical supply network of the railway vehicle.

10. The railway vehicle of claim 1, wherein the light strip comprises a transparent outer protective layer which covers the light source.
